(19) United States
(12) Patent Application Publication
(10) Pub. No.: US 2025/0317958 A1
(43) Pub. Date: Oct. 9, 2025

(54) LOGICAL CHANNEL PRIORITIZATION USING DELAY STATUS REPORT AND PROTOCOL DATA UNIT SET IMPORTANCE INFORMATION

(71) Applicant: QUALCOMM Incorporated, San Diego, CA (US)

(72) Inventors: Sitaramanjaneyulu KANAMARLAPUDI, San Diego, CA (US); Linhai HE, San Diego, CA (US); Ozcan OZTURK, San Diego, CA (US); Sherif ELAZZOUNI, San Diego, CA (US)

(21) Appl. No.: 18/629,621

(22) Filed: Apr. 8, 2024

(51) Int. Cl. H04W 72/56; H04W 28/02; H04W 28/22; H04W 72/1268

(52) U.S. Cl. CPC H04W 72/56; H04W 28/0278; H04W 28/22; H04W 72/1268

(57) ABSTRACT

Various aspects of the present disclosure generally relate to wireless communication. In some aspects, a user equipment (UE) may allocate uplink resources to one or more logical channels based at least in part on a logical channel prioritization (LCP) procedure, wherein the LCP procedure is based at least in part on a logical channel priority parameter and at least one of a delay status report parameter or a protocol data unit set importance parameter. The UE may transmit a medium access control transport block using the uplink resources based at least in part on allocating the uplink resources to the one or more logical channels. Numerous other aspects are described.

### FIELD OF THE DISCLOSURE

Aspects of the present disclosure generally relate to wireless communication and specifically relate to techniques, apparatuses, and methods for logical channel prioritization using delay status report and protocol data unit set importance information.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include allocating uplink resources to one or more logical channels based at least in part on a logical channel prioritization (LCP) procedure, wherein the LCP procedure is based at least in part on a logical channel priority parameter and at least one of a delay status report (DSR) parameter or a protocol data unit (PDU) set importance (PSI) parameter. The method may include transmitting a medium access control transport block (MAC-TB) using the uplink resources based at least in part on allocating the uplink resources to the one or more logical channels.

Some aspects described herein relate to a UE for wireless communication. The UE may include one or more memories and one or more processors coupled to the one or more memories. The one or more processors may be configured to allocate uplink resources to one or more logical channels based at least in part on an LCP procedure, wherein the LCP procedure is based at least in part on a logical channel priority parameter and at least one of a DSR parameter or a PSI parameter. The one or more processors may be configured to transmit a MAC-TB using the uplink resources based at least in part on allocating the uplink resources to the one or more logical channels.

Some aspects described herein relate to a non-transitory computer-readable medium that stores a set of instructions for wireless communication by a UE. The set of instructions, when executed by one or more processors of the UE, may cause the UE to allocate uplink resources to one or more logical channels based at least in part on an LCP procedure, wherein the LCP procedure is based at least in part on a logical channel priority parameter and at least one of a DSR parameter or a PSI parameter. The set of instructions, when executed by one or more processors of the UE, may cause the UE to transmit a MAC-TB using the uplink resources based at least in part on allocating the uplink resources to the one or more logical channels.

Some aspects described herein relate to an apparatus for wireless communication. The apparatus may include means for allocating uplink resources to one or more logical channels based at least in part on an LCP procedure, wherein the LCP procedure is based at least in part on a logical channel priority parameter and at least one of a DSR parameter or a PSI parameter. The apparatus may include means for transmitting a MAC-TB using the uplink resources based at least in part on allocating the uplink resources to the one or more logical channels.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of a user plane protocol stack and a control plane protocol stack for a network node and a core network in communication with a UE, in accordance with the present disclosure.

FIGS. 5A-5C are diagrams of examples associated with logical channel prioritization (LCP) using delay status report (DSR) and protocol data unit (PDU) set importance (PSI) information, in accordance with the present disclosure.

FIG. 6 is a diagram illustrating an example process performed, for example, at a UE or an apparatus of a UE, in accordance with the present disclosure.

FIG. 7 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In wireless communication networks, a medium access control (MAC) layer of a user equipment (UE) may perform a logical channel prioritization (LCP) procedure and/or may use an LCP algorithm when a new transmission is to be performed by the UE. “LCP” may refer to a fundamental MAC procedure used when building a transport block (TB) (sometimes referred to herein as a MAC-TB and/or a MAC protocol data unit (PDU)) from existing bearers and associated data. In some examples, the UE may be configured with, for each logical channel, a logical channel priority parameter (sometimes referred to as priority, with a low numerical priority corresponding to a high transmission priority), a prioritized bit rate (PBR) parameter (sometimes referred to as prioritizedBitRate), and/or a bucket size duration (BSD) parameter (sometimes referred to as bucketSizeDuration), among other parameters. The UE may initialize a variable known as “Bj” to zero when each logical channel j is established, and the value of Bj may be incremented by the product of PBR×T in advance of each LCP procedure, where the value of T is equal to the time period since the value of Bj was previously updated. This product (e.g., PBR×T) represents the volume of data which the logical channel is required to transfer to achieve its PBR (e.g., prioritizedBitRate). In some examples, if the calculated value of Bj exceeds the bucket size (which may be determined according to the product of PBR×BSD), then the value of Bj is rounded down to the bucket size (e.g., if the value of Bj is greater than the bucket size, Bj is set to the bucket size).

When a new transmission is performed (e.g., when a new MAC-TB is compiled), the UE may perform an LCP procedure to allocate resources to the logical channels in a decreasing priority order. More particularly, the UE 120 may select the logical channel that has the lowest numerical logical channel priority parameter (e.g., priority) and a positive value of Bj. If the selected logical channel has a PBR parameter (e.g., prioritizedBitRate) set to “infinity,” the buffer belonging to that logical channel is emptied (sometimes referred to herein as draining the buffer) before serving any other logical channel. Otherwise, the selected logical channel is allocated sufficient resources to achieve the PBR (e.g., the transmit buffer for the logical channel is emptied by at least the value of Bj). The value of Bj may then be updated by subtracting the quantity of data emptied from the buffer. If any resources remain after serving the first logical channel, additional logical channels are served based upon their logical channel priority parameter (e.g., such that the logical channels are served in a decreasing order of priority) regardless of the value of Bj (e.g., without accounting for the value of Bj) until either the data for that logical channel or the uplink grant is exhausted, whichever comes first.

In some examples, the above-described LCP procedure may be poorly suited to handle dynamic flows and/or varying types of traffic. For example, configuration of priority levels may be semi-static and thus may not adapt well to dynamic traffic, and/or priority levels may be predicated on limited coordination of the flow level fine granularity between a radio access network (RAN) entity and a core network entity, and thus may not be capable of accounting for the dynamic nature of modern traffic. As a result, intended quality of service (QoS) requirements for various traffic and/or flows may not be realized with semi-static configurations, resulting in poor priority handling, decreased user experience, and/or inefficient allocation of network resources. Moreover, in light of the inability of semi-static configurations to ensure an appropriate QoS handling, certain applications at the UE may employ forward error correction (FEC) techniques in order to enable a certain level of packet loss and thus avoid retransmission associated delay. This may result in high overhead and thus low bandwidth.

In some examples, data at a UE may be associated with certain application-level QoS handling parameters such as a PDU set error rate (PSER) parameter, a PDU set integrated handling information (PSIHI) parameter, a PDU set delay budget (PSDB) parameter, and/or a PDU set importance (PSI) parameter, and/or a UE may be configured to transmit a delay status report (DSR) to the network to indicate certain information on a radio bearer level, such as an amount of data that is requested to be transmitted within a certain time period for each radio bearer. However, when using the semi-static configuration described above (e.g., semi-statically assigning a priority value per logical channel, among other examples) to meet DSR traffic related PSER, the network node may need to allocate large quantities of uplink resources to the UE in order to meet conditions associated with the DSR and/or to meet certain application-specific priority metrics, which may be sub-optimal from a radio resource management (RRM) perspective.

Various aspects relate generally to an enhanced LCP procedure. Some aspects more specifically relate to an LCP procedure that is based at least in part on delay-specific information (e.g., information associated with a DSR) and/or PDU-set-related information (e.g., information associated with a PSI). In some aspects, delay-specific information and/or PDU-set-related information may be embedded into a MAC LCP algorithm (e.g., in addition to logical-channel-priority-related information) and/or a UE may be configured and/or triggered to use the delay-specific information and/or the PDU-set-related information when building the MAC-TB. In this way, the network has flexibility to choose between the UE performing an LCP procedure based on logical-channel-priority-related information alone (e.g., using a legacy procedure to allocate resources based on priority values and/or Bj values for various logical channels) or else based on additional criteria (e.g., delay-specific information and/or PDU-set-related information) according to a type of traffic, a network slice, a vertical segment, and/or other characteristics.

Particular aspects of the subject matter described in this disclosure can be implemented to realize one or more of the following potential advantages. In some examples, by building a MAC-TB based on an LCP that incorporates delay-specific information and/or PDU-set-related information, the described techniques can be used to achieve QoS handling of certain PDU sets and/or to reduce overhead associated with FEC mechanisms or similar error correction schemes otherwise implemented to compensate for packet loss. Additionally, or alternatively, by enabling the network to flexibly configure and/or trigger a UE to consider delay-specific information and/or PDU-set-related information in an LCP procedure, the described techniques can be used to optimize allocation of network resources in order to handle high-priority traffic and/or to achieve more efficient usage of network resources.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

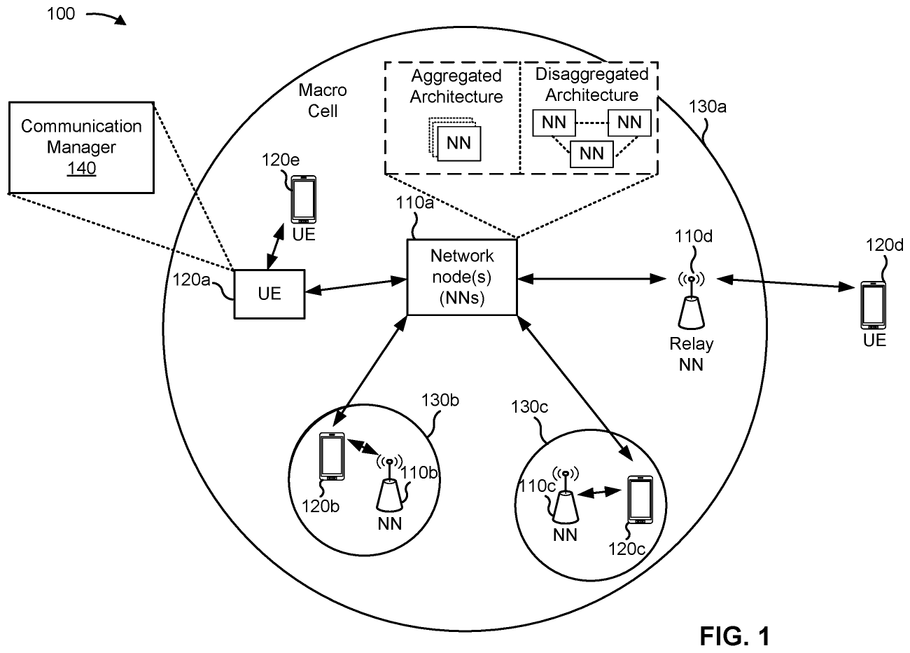

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may allocate uplink resources to one or more logical channels based at least in part on an LCP procedure, wherein the LCP procedure is based at least in part on a logical channel priority parameter and at least one of a DSR parameter or a PSI parameter; and transmit a MAC-TB using the uplink resources based at least in part on allocating the uplink resources to the one or more logical channels. Additionally, or alternatively, the communication manager 140 may perform one or more other operations described herein.

As indicated above, FIG. 1 is provided as an example. Other examples may differ from what is described with regard to FIG. 1.

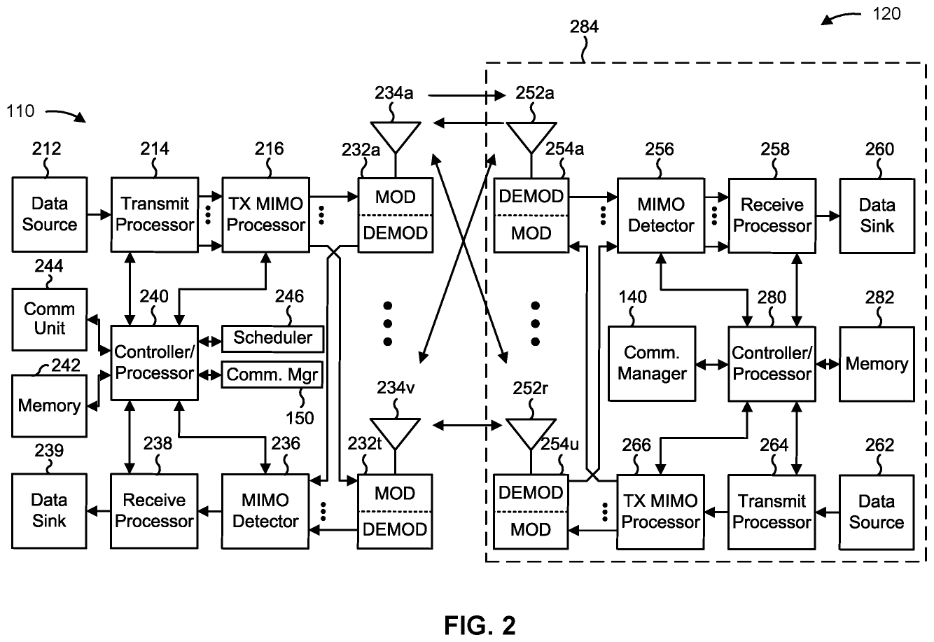

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

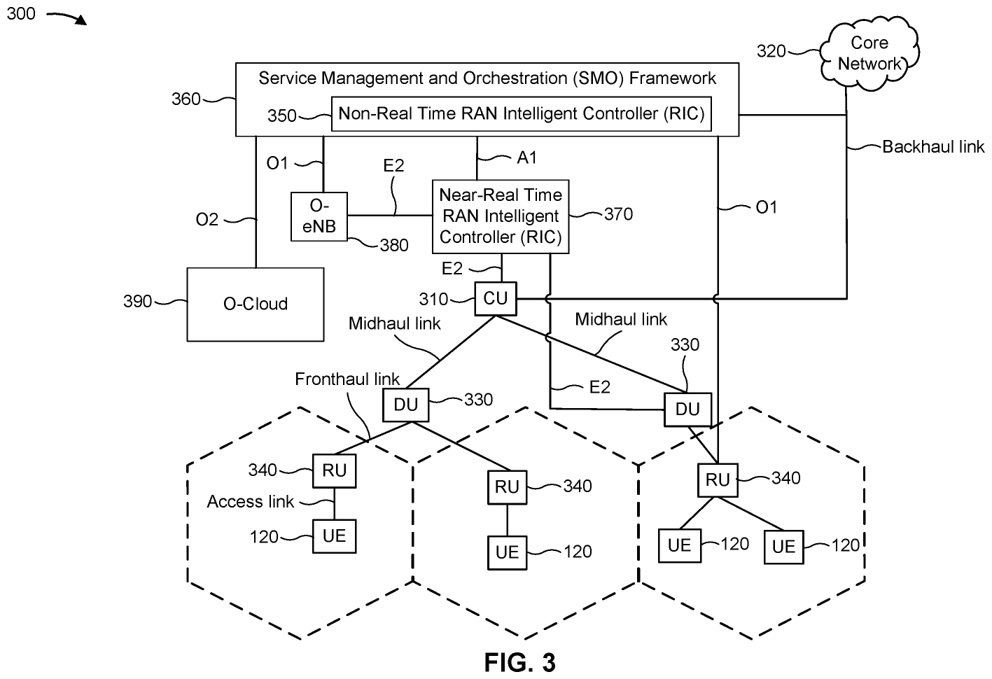

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

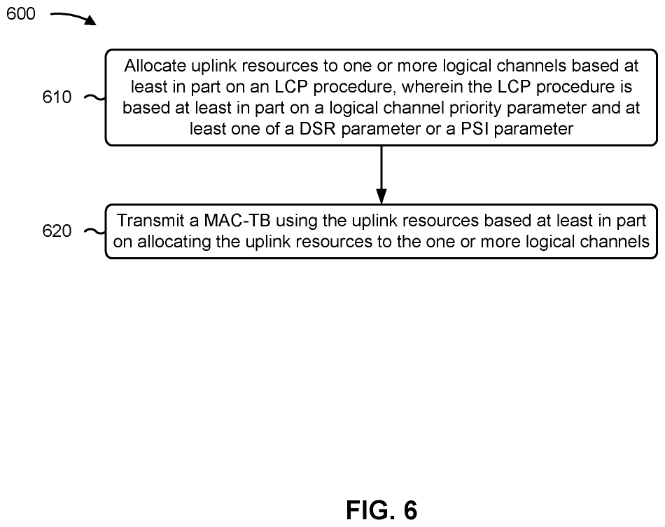

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with LCP using DSR and PSI information, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 600 of FIG. 6, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 600 of FIG. 6, or other processes as described herein. In some examples, executing instructions may include running the instructions, converting the instructions, compiling the instructions, and/or interpreting the instructions, among other examples.

In some aspects, the UE 120 includes means for allocating uplink resources to one or more logical channels based at least in part on an LCP procedure, wherein the LCP procedure is based at least in part on a logical channel priority parameter and at least one of a DSR parameter or a PSI parameter; and/or means for transmitting a MAC-TB using the uplink resources based at least in part on allocating the uplink resources to the one or more logical channels. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

As indicated above, FIG. 3 is provided as an example. Other examples may differ from what is described with regard to FIG. 3.

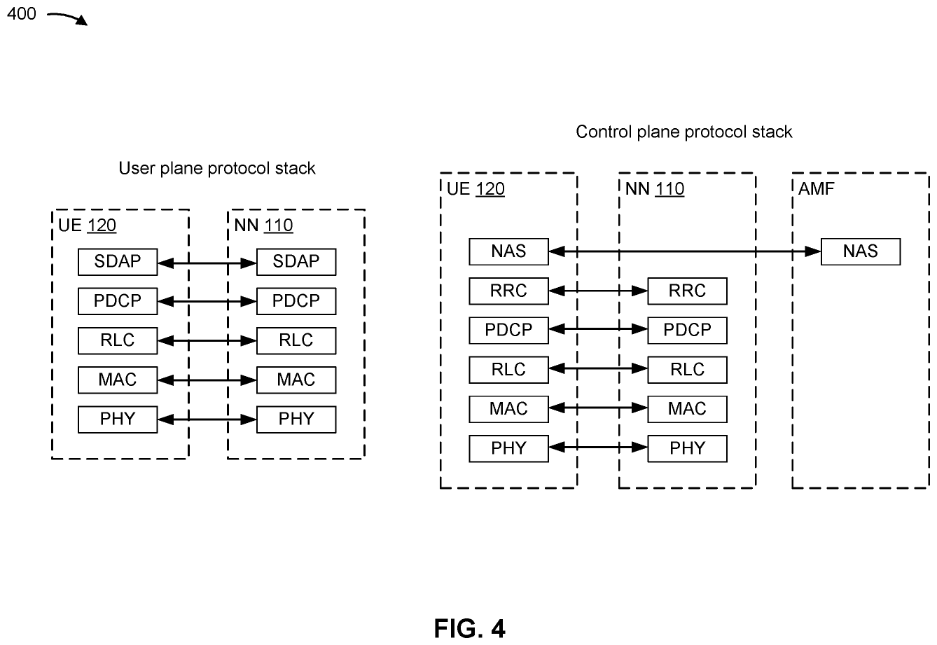

FIG. 4 is a diagram illustrating an example 400 of a user plane protocol stack and a control plane protocol stack for a network node 110 and a core network in communication with a UE 120, in accordance with the present disclosure. In some aspects, the network node 110 may include a plurality of network nodes 110. In some aspects, protocol stack functions of the network node 110 may be distributed across multiple network nodes 110. For example, a first network node 110 may implement a first layer of a protocol stack and a second network node 110 may implement a second layer of the protocol stack. The distribution of the protocol stack across network nodes (in examples where the protocol stack is distributed across network nodes) may be based at least in part on a functional split, as described elsewhere herein. It should be understood that references to “a network node 110” or “the network node 110” can, in some aspects, refer to multiple network nodes.

On the user plane, the UE 120 and the network node 110 may include respective physical (PHY) layers, MAC layers, radio link control (RLC) layers, packet data convergence protocol (PDCP) layers, and service data adaptation protocol (SDAP) layers. A user plane function may handle transport of user data between the UE 120 and the network node 110. On the control plane, the UE 120 and the network node 110 may include respective RRC layers. Furthermore, the UE 120 may include a non-access stratum (NAS) layer in communication with an NAS layer of an access and management mobility function (AMF). The AMF may be associated with a core network associated with the network node 110, such as a 5G core network (5GC) or a next-generation radio access network (NG-RAN). A control plane function may handle transport of control information between the UE 120 and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 4, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); QoS management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from transport blocks (TBs) delivered to/from the physical layer on transport channels, scheduling information reporting, error correction through hybrid ARQ (HARQ), priority handling between UEs by means of dynamic scheduling, priority handling between logical channels of one UE by means of logical channel prioritization, and padding.

The MAC layer may package data from logical channels into TBs (e.g., MAC-TBs and/or MAC PDUs), and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

In some examples, the MAC layer may perform an LCP procedure and/or may use an LCP algorithm when a new transmission is to be performed by the UE 120. “LCP” may refer to a fundamental MAC procedure used when building a TB (e.g., a MAC-TB and/or a MAC PDU) from existing bearers and associated data. In some examples, the UE 120 may be configured, for each logical channel, with a logical channel configuration (sometimes referred to as LogicalChannelConfig), which may include a logical channel priority parameter (e.g., priority), a PBR parameter (e.g., prioritizedBitRate), and/or a BSD parameter (e.g., bucketSizeDuration), among other parameters. The logical channel priority parameter (e.g., priority) may indicate a relative priority level of a logical channel, with a low numerical priority corresponding to a high priority level. In some examples, the PBR parameter (e.g., prioritizedBitRate) may be set to one of 0 kilobytes per second (kBps), 8 kBps, 16 kBps, 32 kBps, 64 kBps, 128 kBps, 256 kBps, and so forth through 8192 kBps, 16,384 kBps, 32,768 kBps, 65,536 kBps, or infinity kBps. Additionally, or alternatively, the BSD parameter (e.g., bucketSizeDuration) may be set to one of 5 milliseconds (ms), 10 ms, 20 ms, 50 ms, 100 ms, 150 ms, 300 ms, 500 ms, or 1000 ms.

In some examples, a variable known as “Bj” may be initialized to zero when each logical channel j is established. The value of Bj may be incremented by the product of PBR×T in advance of each LCP procedure, where the value of T is equal to the time period since the value of Bj was previously updated. This product (e.g., PBR×T) represents the volume of data which the logical channel is required to transfer to achieve its PBR (e.g., prioritizedBitRate). In some examples, if the calculated value of Bj exceeds the bucket size (which may be determined according to the product of PBR×BSD), then the value of Bj is rounded down to the bucket size (e.g., if the value of Bj is greater than the bucket size, Bj is set to the bucket size).

When a new transmission is performed (e.g., when a new MAC-TB is compiled), the UE 120 (e.g., the MAC layer of the UE 120) may perform an LCP procedure to allocate resources to the logical channels in a decreasing priority order. More particularly, the UE 120 may select the logical channel that has the lowest numerical logical channel priority parameter (e.g., priority) and a positive value of Bj. If the selected logical channel has a PBR parameter (e.g., prioritizedBitRate) set to “infinity,” the buffer belonging to that logical channel is emptied (e.g., drained) before serving any other logical channel. Otherwise, the selected logical channel is allocated sufficient resources to achieve the PBR (e.g., the transmit buffer for the logical channel is emptied by at least the value of Bj). The value of Bj may then be updated by subtracting the quantity of data emptied from the buffer. In that regard, in some examples, such as examples in which the PBR is set to infinity, the value of Bj may become negative. If any resources remain after serving the first logical channel, additional logical channels are served based upon their logical channel priority parameter (e.g., such that the logical channels are served in a decreasing order of priority) regardless of the value of Bj (e.g., without accounting for the value of Bj) until either the data for that logical channel or the uplink grant is exhausted, whichever comes first. In some examples, logical channels configured with an equal logical channel priority parameter (e.g., priority) may be served equally. The UE 120 may thus generate a MAC-TB (e.g., a MAC PDU) by multiplexing the data from the one or more logical channels for which uplink resources were allocated per the LCP procedure described above.

In some examples, the above-described LCP procedure may be based on certain assumptions that may not hold true for dynamic flows and/or for varying types of traffic. For example, the LCP procedure may be based on assumptions that different PDU sessions exist for different services, that different QoS flows may be mapped to different radio bearers, and/or that different radio bearers are grouped among different logical channel groups (LCGs) appropriately in light of the traffic and its characteristics, among other examples. However, these assumptions may not hold true in light of the dynamic and/or varying nature of modern traffic. For example, a number of services and QoS requirements per flow may be application-specific and/or may be dynamic, such as bursty traffic, haptic traffic, priority traffic, and other types of traffic. Nonetheless, multiple flows may be mapped to a single radio bearer, with each radio bearer mapped to a single logical cannel and one or more logical channels in turn being mapped to a single LCG.

On the other hand, configuration information (e.g., LogicalChannelConfig, which may set a logical channel priority (e.g., priority) for a logical channel) from a network may be semi-static and/or may be predicated on limited coordination of the flow level fine granularity between a RAN entity and a core network entity, and thus may not be capable of accounting for the dynamic nature of modern traffic. As a result, intended QoS requirements for various traffic and/or flows may not be realized with semi-static configurations (e.g., it may be difficult to semi-statically configure a UE such that a flow may be appropriately mapped to a radio bearer, logical channel, LCG, and ultimately an uplink resource in order to ensure both latency and block error rate (BLER) key performance indicators (KPIs) for the given QoS requirements of the flow are met). This may result in poor priority handling, decreased user experience, and/or inefficient allocation of network resources. Moreover, in light of the inability of semi-static configurations to ensure an appropriate QoS handling, certain applications at the UE may employ FEC techniques in order to enable a certain level of packet loss and thus avoid retransmission associated delay (e.g., FEC techniques implemented at the application level and/or performed using outer coding at the radio level, among other examples). This may result in high overhead and thus low bandwidth.

In some examples, due to the dynamic nature of modern traffic and/or in light of certain QoS needs of certain verticals such as extended reality (XR) applications and/or similar verticals where latency and/or BLER may be significant, and/or due to the advent of certain application-level QoS handling metrics such as PSER, PSIHI, PSDB, and/or PSI, a UE may be configured to transmit certain reports to a network node. For example, in addition to a buffer status report (BSR), which may be a MAC-CE transmitted by a UE to a network node carrying information about how much data is in a UE buffer, a UE may be configured to transmit, to a network node, a DSR. The DSR may indicate certain information on a radio bearer level, such as an amount of data that is requested to be transmitted within a certain time period for each radio bearer. For example, a DSR may indicate, for each radio bearer and/or logical channel, a first amount of data that is to be transmitted within a first time period (e.g., 50 ms), a second amount of data that is to be transmitted within a second time period (e.g., 100 ms), and so forth. In such examples, a network node may grant uplink resources based on the DSR (e.g., in addition to the BSR), such as for a purpose of ensuring that DSR traffic is timely transmitted.

However, when using the semi-static configuration described above (e.g., using the logicChannelConfig to assign a priority value per logical channel, among other examples) to meet DSR traffic related PSER, the network node may need to allocate large quantities of uplink resources to the UE in order to meet conditions associated with the DSR, which may not be optimal from an RRM perspective and/or a UE perspective. For example, a UE may transmit a BSR indicating how much data is ready to be transmitted for each of multiple logical channels and/or corresponding radio bearers. Additionally, the UE may transmit a DSR indicating, for each radio bearer and/or logical channel, time periods when portions of the data are to be transmitted. For example, as summarized in the below table, a UE may transmit, to a network node, a BSR indicating that for a highest priority (e.g., according to the priority configuration) radio bearer and/or logical channel, the UE has 100 kB of data to transmit; that for a second-highest priority radio bearer and/or logical channel, the UE has 200 kB of data to transmit; and/or that for a third-highest priority radio bearer and/or logical channel, the UE has 300 kB of data to transmit. Additionally, or alternatively, and as further summarized in the below table, the UE may transmit a DSR indicating that for the first radio bearer and/or logical channel, 20 kB of data needs to be transmitted within 50 ms and 30 kB of data needs to be transmitted within 100 ms; that for the second radio bearer and/or logical channel, 50 kB of data needs to be transmitted within 50 ms and 50 kB of data needs to be transmitted within 100 ms; and that for the third radio bearer and/or logical channel, 20 kB of data needs to be transmitted within 50 ms and 50 kB of data needs to be transmitted within 100 ms.

| | Radio Bearer | | | |
|---|---|---|---|---|
| Logical Channel | Priority | BSR | DSR (50 ms) | DSR (100 ms) |
| 1 | 1 | 100 kB | 20 kB | 30 kB |
| 2 | 2 | 200 kB | 50 kB | 50 kB |
| 3 | 3 | 300 kB | 20 kB | 50 kB |

In such examples, assuming that Bj for each logical channel is infinite, for ease of description, if the network node wishes to drain the data that needs to be transmitted within 50 ms according to the DSR, the network node needs to grant the UE resources that support at least 320 kB of data. This is because, under the LCP procedure described above, the UE may need to drain all data associated with the first two logical channels before draining any data associated with the third logical channel, which is associated with 20 kB of DSR 50 ms traffic. Accordingly, of the 320 kB granted in this scenario, 100 KB may be used to drain the data in the buffer associated with the first logical channel, 200 kB may be used to drain the data in the buffer associated with the second logical channel, and 20 kB may be used to drain the data associated with the DSR 50 ms level in the buffer associated with the third logical channel. Accordingly, the semi-static configuration of the UE with the various priority values and/or the LCP algorithm implemented by the UE may be sub-optimal from an RRM perspective, because, although in the above example the UE only has 90 KB of total DSR 50 ms level data, the network node must allocate resources sufficient to transmit 320 kB of data in order to drain the DSR 50 ms level data.

Some implementations described herein enable enhanced LCP procedures that are associated with delay-specific information and/or other PDU-set-related information. In some aspects, a UE may build a MAC-TB (e.g., a MAC PDU) by allocating uplink resources to one or more logical channels based at least in part on an LCP procedure that is based at least in part on a logical channel priority parameter (e.g., the semi-statically configured priority parameter), a DSR parameter (sometimes referred to herein as Di, which may be a parameter associated with a DSR transmitted by the UE to a network node), and/or a PSI parameter (sometimes referred to as Fi). In some aspects, if a DSR parameter trigger (e.g., a Di trigger) is configured, the UE (e.g., a MAC layer of the UE) may first drain traffic from the DSR Di delay level when building the MAC-TB. Additionally, or alternatively, if a PSI parameter trigger (e.g., a Fi trigger) is configured, the UE (e.g., a MAC layer of the UE) may next drain traffic from the PSI Fi priority level when building the MAC-TB. Additionally, or alternatively, the UE may then drain traffic accordingly to the LCP procedure described above (e.g., draining traffic based at least in part on the relative priority level associated with the various logical channels). As a result, the enhanced LCP procedures described herein may improve QoS handling of certain PDU sets, optimize allocation of network resources to handle high-priority traffic, reduce overhead associated with FEC mechanisms or similar error correction schemes otherwise implemented to compensate for packet loss, and/or result in more efficient usage of network resources.

As indicated above, FIG. 4 is provided as an example. Other examples may differ from what is described with regard to FIG. 4.

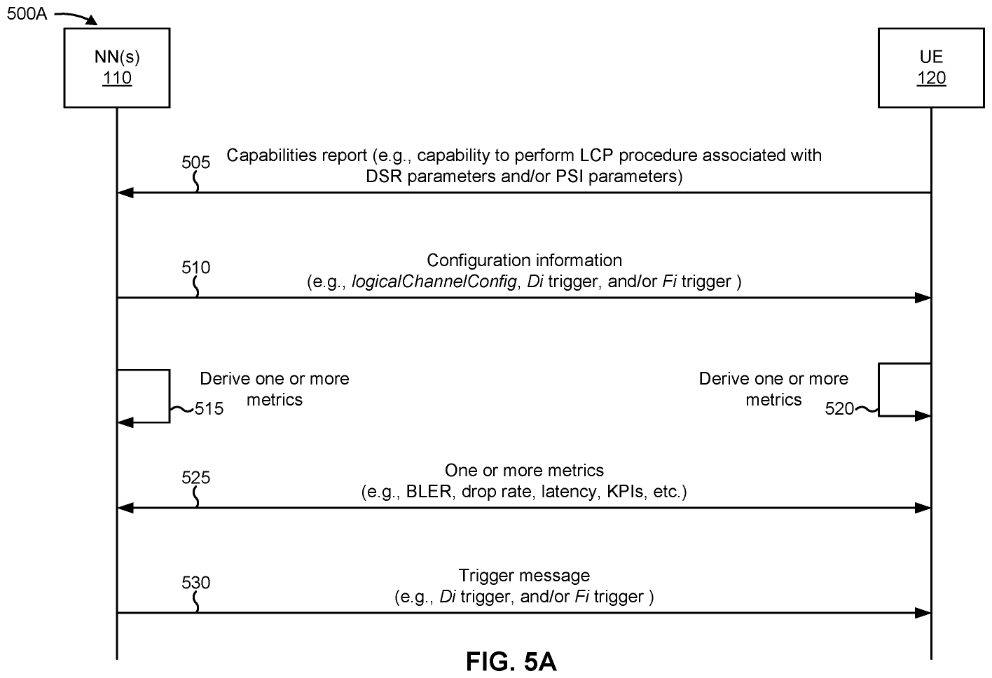

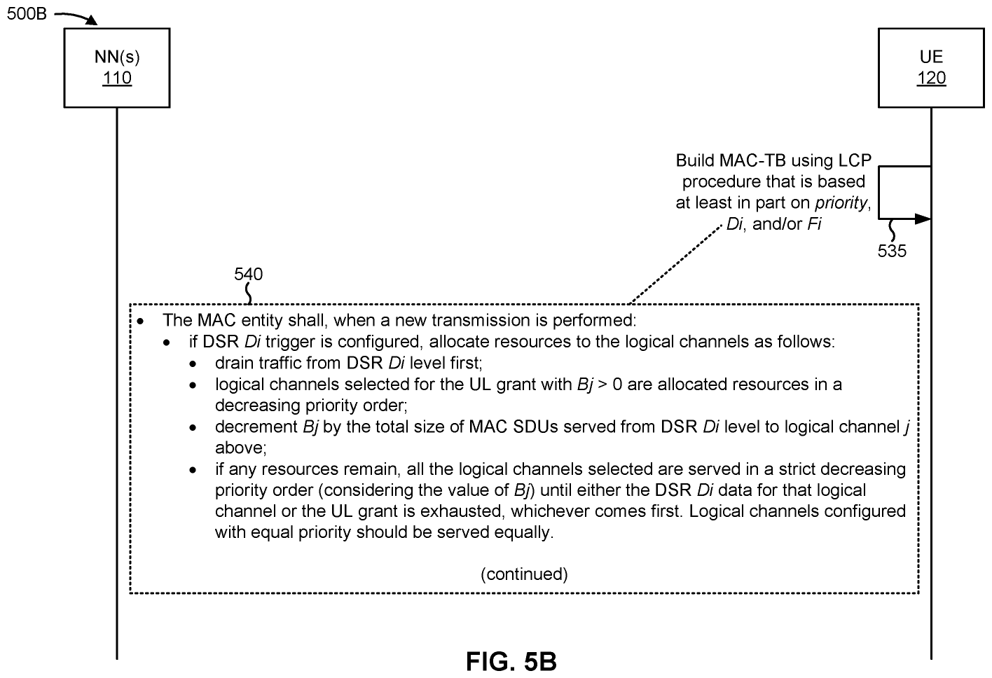

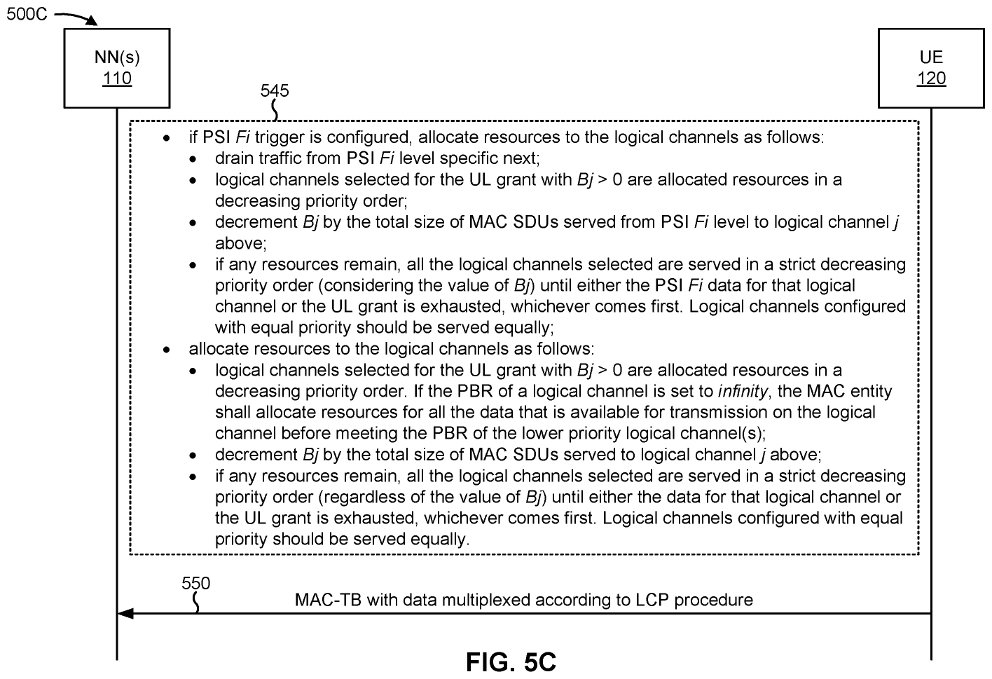

FIGS. 5A-5C are diagrams of examples associated with LCP using DSR and PSI information, in accordance with the present disclosure. As shown in FIGS. 5A-5C, a network node 110 (e.g., a base station, a CU, a DU, and/or an RU) may communicate with a UE 120. In some aspects, the network node 110 and the UE 120 may be part of a wireless network (e.g., wireless communication network 100). The UE 120 and the network node 110 may have established a wireless connection prior to operations shown in FIGS. 5A-5C. In some aspects, the network node 110 may provide uplink grants to the UE 120 indicating resources to be used for uplink transmissions, and/or the UE 120 may be capable of allocating the resources to one or more logical channels using an enhanced LCP procedure, as described in more detail.

As shown by example 500A in FIG. 5A, and as indicated by reference number 505, the UE 120 may transmit, and the network node 110 may receive, a capabilities report. The capabilities report may indicate whether the UE 120 supports a feature and/or one or more parameters related to the feature. For example, the capability information may indicate a capability and/or parameter for performing an enhanced LCP procedure. As another example, the capabilities report may indicate a capability and/or parameter for performing an LCP procedure that is based at least in part on a logical channel priority parameter, a DSR parameter, and/or a PSI parameter. One or more operations described herein may be based on capability information of the capabilities report. For example, the UE 120 may perform a communication in accordance with the capability information, or may receive configuration information that is in accordance with the capability information. In some aspects, the capabilities report may indicate UE 120 support for building a MAC-TB (e.g., a MAC PDU) by allocating uplink resources to one or more logical channels based at least in part on an LCP procedure that takes into account delay specific information (e.g., information associated with one or more DSRs), PDU set priority related information (e.g., information associated with one or more PSIs), and/or logical channel priority information (e.g., information associated with one or more semi-statically configured priority values), among other examples.

As shown by reference number 510, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein, such as the trigger message described below in connection with reference number 530) may include a dynamic indication, such as one or more MAC-CEs and/or one or more DCI messages, among other examples.

In some aspects, the configuration information may indicate, for each of multiple logical channels, a logical channel configuration (e.g., logicalChannelConfig). In such aspects, each logical channel configuration may indicate, for a respective logical channel, a priority value of the logical channel (e.g., priority), a PBR of the logical channel (e.g., prioritizedBitRate), a BSD of the logical channel (e.g., bucketSizeDuration), allowed cells for transmission for the logical channel (sometimes referred to as allowedServingCells), allowed one or more subcarrier spacings (SCSs) for transmission for the logical channel (sometimes referred to as allowedSCS-List), a maximum PUSCH duration allowed for transmission for the logical channel (sometimes referred to as maxPUSCH-Duration), whether a configured grant Type 1 can be used for transmission for the logical channel (sometimes referred to as configuredGrantType1Allowed), an LCG for the logical channel (sometimes referred to as logicalChannelGroup), a scheduling request identifier for the logical channel (sometimes referred to as schedulingRequestID), a scheduling request mask for the logical channel (sometimes referred to as logicalChannelSR-Mask), a scheduling request (SR) delay timer applied for the logical channel (sometimes referred to as logicalChannelSR-DelayTimerApplied), and/or a bit rate query prohibit timer for the logical channel (sometimes referred to as bitRateQueryProhibitTimer), among other examples.

In some aspects, the configuration information may indicate whether the UE 120 is to consider certain delay-specific parameters (e.g., Di, described in more detail below, and/or a similar parameter), PDU-set-priority-specific parameters (e.g., Fi, described in more detail below, and/or a similar parameter), and/or similar parameters when performing LCP procedures. For example, the configuration information may configure the UE 120 to prioritize traffic associated with a certain DSR level (e.g., Di) when building a MAC-TB, and/or the configuration information may configure the UE 120 to prioritize traffic associated with a certain PSI level (e.g., Fi) when building a MAC-TB, among other examples. In some aspects, the configuration information may include a trigger message (e.g., the configuration information may include an indication triggering Di prioritization in an LCP procedure and/or the configuration information may include an indication triggering Fi prioritization in an LCP procedure, among other examples), and/or the configuration may correspond to the trigger message described elsewhere herein. Additionally, or alternatively, in some aspects the network node 110 may dynamically indicate (e.g., via a MAC-CE, DCI, and/or a similar communication) to the UE 120 whether Di prioritization and/or Fi prioritization are to be performed in an LCP procedure, which is described in more detail below in connection with reference number 530. In such aspects, the configuration information may omit one or both of a Di trigger message and/or an Fi trigger message.

The UE 120 may configure itself based at least in part on the configuration information. In some aspects, the UE 120 may be configured to perform one or more operations described herein based at least in part on the configuration information.

In some aspects, the configuration information described in connection with reference number 510 and/or the capabilities report described above in connection with reference number 505 may include information transmitted via multiple communications. Additionally, or alternatively, the network node 110 may transmit the configuration information, or a communication including at least a portion of the configuration information, before and/or after the UE 120 transmits the capabilities report. For example, the network node 110 may transmit a first portion of the configuration information before the capabilities report, the UE 120 may transmit at least a portion of the capabilities report, and the network node 110 may transmit a second portion of the configuration information after receiving the capabilities report.

In some aspects, whether the UE 120 is to prioritize DSR-based traffic (e.g., perform Di prioritization) and/or PSI-based traffic (e.g., perform Fi prioritization) may be based at least in part on metrics derived at one of the UE 120 or the network node 110. For example, whether the UE 120 is to prioritize DSR-based traffic and/or PSI-based traffic may be semi-statically configured (as described above in connection with reference number 510) and/or may be dynamically indicated. In aspects in which whether the UE 120 is to prioritize DSR-based traffic and/or PSI-based traffic is dynamically indicated, the UE 120 and/or the network node 110 may derive certain metrics, and the network node 110 may transmit a dynamic indication based at least in part on the metrics. For example, in some aspects, as indicated by reference number 515, the network node 110 may derive one or more metrics, such as a BLER metric, a drop rate metric, a latency metric, a video condition metric, a channel quality metric, a round trip time (RTT) metric, and/or another KPI, among other examples. Additionally, or alternatively, in some aspects, as indicated by reference number 520, the UE 120 may derive one or more metrics, such as a BLER metric, a drop rate metric, a latency metric, a video condition metric, a channel quality metric, an RTT metric, and/or another KPI, among other examples. In some aspects, the network node 110 and/or the UE 120 may derive the one or more metrics using one or more AI/ML models running at the network node 110 and/or the UE 120, respectively.

Additionally, or alternatively, in some aspects the network node 110 and/or the UE 120 may exchange information about one or more metrics derived using AI/ML models, or otherwise. Put another way, in some aspects, whether the UE 120 is to prioritize DSR-based traffic and/or PSI-based traffic may be based at least in part on coordination between peers (e.g., the network node 110 and the UE 120, among other examples) to meet certain service QoS requirements, or the like. For example, as indicated by reference number 525, in some aspects, the network node 110 may transmit, and the UE 120 may receive, a communication indicating one or more metrics associated with traffic between the network node 110 and/or the UE 120. Similarly, in some other aspects, the UE 120 may transmit, and the network node 110 may receive, a communication indicating one or more metrics associated with traffic between the network node 110 and/or the UE 120. Based at least in part on the metrics, the network node 110 and/or the UE 120 may identify whether the UE 120 is to prioritize DSR-based traffic and/or PSI-based traffic during an LCP procedure. For example, if at least one metric falls below a corresponding threshold, the network node 110 and/or the UE 120 may determine that the UE 120 is to prioritize DSR-based traffic and/or PSI-based traffic during an LCP procedure in order to meet service QoS requirements for certain flows and/or applications, among other examples.

In some aspects, the network node 110 may dynamically indicate to the UE 120 whether the UE 120 is to prioritize DSR-based traffic (e.g., perform Di prioritization) and/or PSI-based traffic (e.g., perform Fi prioritization) during an LCP procedure, as described above. Put another way, in some aspects, a Di trigger message and/or an Fi trigger message may be dynamically transmitted by the network node 110 to the UE 120. For example, as indicated by reference number 530, the network node 110 may transmit, and the UE 120 may receive, a trigger message indicating whether at least one of the DSR parameter (e.g., Di) or the PSI parameter (e.g., Fi) is to be considered by the UE 120 when creating the MAC-TB (e.g., when generating the MAC-TB by multiplexing data from one or more logical channels, among other information such as one or more MAC-CEs).

For example, the network node 110 may configure (e.g., via the configuration information described above in connection with reference number 510) the UE 120 with one or more Di levels (e.g., one or more DSR levels), with a default being no Di levels configured. For example, the network node 110 may configure the UE 120 with a first Di level (e.g., D1) corresponding to data that is to be transmitted within 50 ms, a second Di level (e.g., D2) corresponding to data that is to be transmitted within 100 ms, and so forth. In such aspects, the trigger message shown in connection with reference number 530 may indicate which one or more Di levels are to be prioritized by the MAC layer of the UE 120 when building the MAC-TB (e.g., the MAC PDU).

Additionally, or alternatively, the network node 110 may configure (e.g., via the configuration information described above in connection with reference number 510) the UE 120 with one or more Fi levels (e.g., one or more flow PSI levels), with a default being no Fi levels configured. For example, the network node 110 may configure the UE 120 with a first Fi level (e.g., F1) corresponding to a priority level of 0 or 1 (with 0 corresponding to a lower priority than 1) and/or a second Fi level (e.g., F2) corresponding to a priority level of the other one of 0 or 1, among other examples. In such aspects, the trigger message shown in connection with reference number 530 may indicate which one or more Fi levels are to be prioritized by the MAC layer of the UE 120 when building the MAC-TB (e.g., the MAC PDU).

In some aspects, the network node 110 may configure and/or trigger the UE 120 to perform Di prioritization and/or Fi prioritization for a particular type of data and/or based on certain characteristics associated with one or more logical channels, among other examples. For example, the trigger message described above in connection with reference number 530 may be based on an FEC procedure associated with data to be included in the MAC-TB. For example, a certain application may employ an FEC procedure, such as for a purpose of compensating for delay-associated packet loss. Accordingly, based on the network node 110 and/or the UE 120 determining that an FEC procedure is being utilized for a given set of data and/or application, the UE 120 may be configured and/or triggered to prioritize that data, such as by performing DSR-based prioritization and/or PSI-based prioritization, among other examples.

Additionally, or alternatively, the UE 120 may be configured and/or triggered to prioritize data associated with a certain network slice. For example, the UE 120 may be configured to prioritize one network slice over another network slice (e.g., a certain network slice may have absolute priority over one or more other network slices), and/or the UE 120 may perform DSR-based prioritization and/or PSI-based prioritization for radio bearers within that network slice. Additionally, or alternatively, the UE 120 may be configured and/or triggered to prioritize data associated with a certain QoS flow. For example, the UE 120 may be configured to prioritize one QoS flow over another QoS flow (e.g., a certain QoS flow may have absolute priority over one or more other QoS flows), and/or the UE 120 may perform DSR-based prioritization and/or PSI-based prioritization for a radio bearer associated with that QoS flow.

Additionally, or alternatively, the UE 120 may be configured and/or triggered to prioritize data based on a network traffic pattern. For example, the UE 120 may be configured to perform DSR-based prioritization and/or PSI-based prioritization during times of heavy network traffic and/or when communication channels are relatively crowded, and/or the UE may be configured to perform only logical-channel-priority-based (e.g., priority-based) prioritization during times of low network traffic and/or when communication channels are relatively uncrowded.

Additionally, or alternatively, the UE 120 may be configured and/or triggered to prioritize data associated with a certain SCS. For example, the UE 120 may be configured to prioritize one or more logical channels associated with one SCS over one or more logical channels associated with another SCS (e.g., logical channels associated with a certain SCS may have absolute priority over logical channels associated with other SCSs), and/or the UE 120 may perform DSR-based prioritization and/or PSI-based prioritization for radio bearers associated with the certain SCS. Additionally, or alternatively, the UE 120 may be configured and/or triggered to prioritize data associated with terrestrial networks and/or nonterrestrial networks (NTNs). For example, the UE 120 may be configured to prioritize one of terrestrial networks or NTNs over the other one of terrestrial networks or NTNs (e.g., one of terrestrial networks or NTNs may have absolute priority over the other one of terrestrial networks or NTNs), and/or the UE 120 may perform DSR-based prioritization and/or PSI-based prioritization for radio bearers associated with the one of terrestrial networks or NTNs.

As shown by example 500B in FIG. 5B, and as indicated by reference number 535, based at least in part on the configuration information described above in connection with reference number 510, the trigger message described above in connection with reference number 530, and/or similar information, the UE 120 (e.g., a MAC layer of the UE 120) may build a MAC-TB (e.g., a MAC PDU) using an LCP procedure that is based on Di, Fi, and/or logical channel priority, among other examples. Put another way, the UE 120 may create a MAC-TB by allocating uplink resources to one or more logical channels using an LCP procedure that is based at least in part on a logical channel priority parameter (e.g., priority), a DSR parameter (e.g., Di), and/or a PSI parameter (e.g., Fi), among other examples, and/or by generating the MAC-TB by multiplexing data from the one or more logical channels (among other information) based at least in part on the allocated resources.

In some aspects, when the UE 120 has been configured and/or triggered to prioritize at least one DSR level (e.g., at least one Di level) and at least one PSI level (e.g., at least one Fi level), the LCP procedure may involve first allocating uplink resources based on prioritizing DSR-based traffic (e.g., based on performing Di-based prioritization), then allocating uplink resources based on prioritizing PSI-based traffic (e.g., based on performing Fi-based prioritization), and then allocating uplink resources based on prioritizing logical channels according to a semi-statically configured logical channel priority value (e.g., based on performing priority-based prioritization). Put another way, in some aspects, allocating the uplink resources to the one or more logical channels based at least in part on the LCP procedure may include allocating a first portion of the uplink resources based at least in part on the DSR parameter (e.g., Di), after allocating the first portion, allocating a second portion of the uplink resources based at least in part on the PSI parameter (e.g., Fi), and after allocating the second portion, allocating a third portion of the uplink resources based at least in part on the logical channel priority parameter (e.g., priority).

More particularly, reference number 540 in FIG. 5B and reference number 545 in FIG. 5C show one example of an LCP procedure that may be performed by a MAC layer of the UE 120 when building the MAC-TB (e.g., the MAC PDU). As indicated by reference number 540, when a new transmission is to be performed, if a DSR Di trigger is configured (e.g., via the configuration information described above in connection with reference number 510, via the dynamic indication described above in connection with reference number 530, and/or otherwise), the UE 120 (e.g., the MAC layer of the UE 120, referred to as “MAC entity” in FIG. 5B) may first allocate resources by prioritizing Di traffic. More particularly, if a DSR Di trigger is configured (e.g., if the network node 110 has indicated to the UE 120 that the UE 120 is to prioritize traffic associated with a given Di level, such as traffic associated with a 50-ms level, 100-ms level, and/or the like), the UE 120 may drain traffic from the Di level first. That is, the UE 120 may prioritize Di traffic such that uplink resources are allocated to the Di traffic before the uplink resources are allocated to any other type of traffic.

In doing so, logical channels selected for the uplink grant with Bj>0 may be allocated resources in a decreasing priority order (e.g., according to the semi-statically configured priority parameter). As used herein, “selected” logical channels are channels that are selected for allocation of uplink resources during the LCP procedure, such as by using an applicable wireless communication standard. For example, in some aspects, logical channels may be selected according to a procedure indicated by clause 5.4.3.1.2 of Technical Specification (TS) 38.321 (e.g., a MAC protocol specification), version 18.0.0, promulgated by the 3GPP. In such aspects, the UE 120 (e.g., the MAC layer of the UE 120) may, when a new transmission is performed, select the logical channels for each uplink grant that satisfy all of the following conditions: (1) the set of allowed SCS index values in allowedSCS-List, if configured, includes the SCS index associated to the uplink grant; (2) maxPUSCH-Duration, if configured, is larger than or equal to the PUSCH transmission duration associated to the uplink grant; (3) configuredGrantTypelAllowed, if configured, is set to true in case the uplink grant is a configured grant Type 1; (4) allowedServingCells, if configured, includes the cell information associated to the uplink grant (which does not apply to logical channels associated with a DRB configured with PDCP duplication within the same MAC entity (e.g., carrier aggregation (CA) duplication) when CA duplication is deactivated for this DRB in this MAC entity); (5) allowedCG-List, if configured, includes the configured grant index associated to the uplink grant; (6) allowedPHY-PriorityIndex, if configured, includes the priority index (as specified in clause 9 of TS 38.213) associated to the dynamic uplink grant; and (7) allowedHARQ-mode, if configured, includes the allowed uplink HARQ mode for the HARQ process associated to the uplink grant.

Moreover, as further indicated by reference number 540, in allocating resources to drain traffic from the DSR Di level first, the UE 120 may decrement Bj by the total size of MAC SDUs served from the DSR Di level to logical channel j. Additionally, or alternatively, if any resources remain, all of the logical channels selected (e.g., according to clause 5.4.3.1.2 of TS 38.321, or otherwise) may be served in a strict decreasing priority order (considering the value of Bj, meaning that only logical channels with positive Bjs may be served and/or that each channel j may receive up to an amount of data corresponding to Bj) until either the DSR Di data for that logical channel or the uplink grant is exhausted, whichever comes first. In such aspects, logical channels configured with equal priority (e.g., priority) may be served equally.

As shown by example 500C in FIG. 5C, and as indicated by reference number 545, after allocating resources based on one or more Di levels, the UE 120 may allocate resources based on one or more Fi levels, if triggered to do so. More particularly, if a PSI Fi trigger is configured (e.g., via the configuration information described above in connection with reference number 510, via the dynamic indication described above in connection with reference number 530, and/or otherwise), the UE 120 (e.g., the MAC layer of the UE 120) may next allocate resources by prioritizing Fi traffic. More particularly, if a PSI Fi trigger is configured (e.g., if the network node 110 has indicated to the UE 120 that the UE 120 is to prioritize traffic associated with a given Fi level, such as traffic associated with PSI 0, PSI 1, or the like), the UE 120 may next drain traffic from the Fi level. That is, the UE 120 may next prioritize Fi traffic such that uplink resources are next allocated to the Fi traffic before the uplink resources are allocated to any other type of traffic.

In doing so, logical channels selected for the uplink grant (e.g., according to the procedure in clause 5.4.3.1.2 of TS 38.321) with Bj>0 may be allocated resources in a decreasing priority order (e.g., according to the semi-statically configured priority parameter). Moreover, in allocating resources to drain traffic from the PSI Fi level, the UE 120 may decrement Bj by the total size of MAC SDUs served from the PSI Fi level to logical channel j. Additionally, or alternatively, if any resources remain, all of the logical channels selected may be served in a strict decreasing priority order (considering the value of Bj, meaning that only logical channels with positive Bjs may be served and/or that each channel j may receive up to an amount of data corresponding to Bj) until either the PSI Fi data for that logical channel or the uplink grant is exhausted, whichever comes first. In such aspects, logical channels configured with equal priority (e.g., priority) may be served equally.

Moreover, after allocating resources based on one or more Di levels and/or then by one or more Fi levels, the UE 120 may allocate resources based on logical channel priority (e.g., based on priority, such as by following an LCP procedure defined by clause 5.4.3.1.3 of TS 38.321). More particularly, the UE 120 (e.g., the MAC layer of the UE 120) may allocate resources to the logical channels by allocating resources to logical channels selected for the uplink grant (e.g., according to the procedure in clause 5.4.3.1.2 of TS 38.321) with Bj>0 in a decreasing priority order (e.g., according to the semi-statically configured priority parameter). In doing so, if a PBR (e.g., prioritizedBitRate) of a logical channel is set to infinity, the UE 120 may allocate resources for all of the data that is available for transmission on the logical channel before meeting the PBR of any lower priority logical channels. Moreover, in allocating resources in this regard, the UE 120 may decrement Bj by the total size of MAC SDUs served to logical channel j. Additionally, or alternatively, if any resources remain, all of the logical channels selected may be served in a strict decreasing priority order (regardless of the value of Bj) until either the data for that logical channel or the uplink grant is exhausted, whichever comes first. In such aspects, logical channels configured with equal priority (e.g., priority) may be served equally.

Although the example described above in connection with reference numbers 540 and 545 is associated with prioritizing DSR traffic over PSI traffic, in some other aspects PSI traffic may be prioritized over DSR traffic. Put another way, in some aspects, when the UE 120 has been configured and/or triggered to prioritize at least one DSR level (e.g., at least one Di level) and at least one PSI level (e.g., at least one Fi level), the LCP procedure may involve first allocating uplink resources based on prioritizing PSI-based traffic (e.g., based on performing Fi-based prioritization), then allocating uplink resources based on prioritizing DSR-based traffic (e.g., based on performing Di-based prioritization), and then allocating uplink resources based on prioritizing logical channels according to a semi-statically configured logical channel priority value (e.g., based on performing priority-based prioritization). In this regard, in some aspects, allocating the uplink resources to the one or more logical channels based at least in part on the LCP procedure may include allocating a first portion of the uplink resources based at least in part on the PSI parameter (e.g., Fi), after allocating the first portion, allocating a second portion of the uplink resources based at least in part on the DSR parameter (e.g., Di), and after allocating the second portion, allocating a third portion of the uplink resources based at least in part on the logical channel priority parameter (e.g., priority).

In such aspects, when a new transmission is to be performed, if a PSI Fi trigger is configured (e.g., via the configuration information described above in connection with reference number 510, via the dynamic indication described above in connection with reference number 530, and/or otherwise), the UE 120 (e.g., the MAC layer of the UE 120) may first allocate resources by prioritizing Fi traffic. More particularly, if a PSI Fi trigger is configured (e.g., if the network node 110 has indicated to the UE 120 that the UE 120 is to prioritize traffic associated with a given Fi level, such as traffic associated with an Fi level of 0 or 1), the UE 120 may drain traffic from the Fi level first. That is, the UE 120 may prioritize Fi traffic such that uplink resources are allocated to the Fi traffic before the uplink resources are allocated to any other type of traffic.

In doing so, logical channels selected for the uplink grant (e.g., according to the procedure in clause 5.4.3.1.2 of TS 38.321) with Bj>0 may be allocated resources in a decreasing priority order (e.g., according to the semi-statically configured priority parameter). Moreover, in allocating resources to drain traffic from the PSI Fi level first, the UE 120 may decrement Bj by the total size of MAC SDUs served from the PSI Fi level to logical channel j. Additionally, or alternatively, if any resources remain, all of the logical channels selected may be served in a strict decreasing priority order (considering the value of Bj, meaning that only logical channels with positive Bjs may be served and/or each channel j may receive up to an amount of data corresponding to Bj) until either the PSI Fi data for that logical channel or the uplink grant is exhausted, whichever comes first. In such aspects, logical channels configured with equal priority (e.g., priority) may be served equally.

Moreover, after allocating resources based on one or more Fi levels, the UE 120 may allocate resources based on one or more Di levels, if triggered to do so. More particularly, if a DSR Di trigger is configured (e.g., via the configuration information described above in connection with reference number 510, via the dynamic indication described above in connection with reference number 530, and/or otherwise), the UE 120 (e.g., the MAC layer of the UE 120) may next allocate resources by prioritizing Di traffic. More particularly, if a DSR Di trigger is configured (e.g., if the network node 110 has indicated to the UE 120 that the UE 120 is to prioritize traffic associated with a given Di level, such as traffic associated with 50 ms, 100 ms, or the like), the UE 120 may next drain traffic from the Di level. That is, the UE 120 may next prioritize Di traffic such that uplink resources are next allocated to the Di traffic before the uplink resources are allocated to any other type of traffic.

In doing so, logical channels selected for the uplink grant (e.g., according to the procedure in clause 5.4.3.1.2 of TS 38.321) with Bj>0 may be allocated resources in a decreasing priority order (e.g., according to the semi-statically configured priority parameter). Moreover, in allocating resources drain traffic from the DSR Di level, the UE 120 may decrement Bj by the total size of MAC SDUs served from the DSR Di level to logical channel j. Additionally, or alternatively, if any resources remain, all of the logical channels selected may be served in a strict decreasing priority order (considering the value of Bj, meaning that only logical channels with positive Bjs may be served and/or that each channel j may receive up to an amount of data corresponding to Bj) until either the DSR Di data for that logical channel or the uplink grant is exhausted, whichever comes first. In such aspects, logical channels configured with equal priority (e.g., priority) may be served equally.

Moreover, after allocating resources based on one or more Fi levels and/or then by one or more Di levels, the UE 120 may allocate resources based on logical channel priority (e.g., based on priority, such as by following an LCP procedure defined by clause 5.4.3.1.3 of TS 38.321). More particularly, the UE 120 (e.g., the MAC layer of the UE 120) may allocate resources to the logical channels by allocating resources to logical channels selected for the uplink grant (e.g., according to the procedure in clause 5.4.3.1.2 of TS 38.321) with Bj>0 in a decreasing priority order (e.g., according to the semi-statically configured priority parameter). In doing so, if a PBR (e.g., prioritizedBitRate) of a logical channel is set to infinity, the UE 120 may allocate resources for all of the data that is available for transmission on the logical channel before meeting the PBR of any lower priority logical channels. Moreover, in allocating resources in this regard, the UE 120 may decrement Bj by the total size of MAC SDUs served to logical channel j. Additionally, or alternatively, if any resources remain, all the logical channels selected may be served in a strict decreasing priority order (regardless of the value of Bj) until either the data for that logical channel or the uplink grant is exhausted, whichever comes first. In such aspects, logical channels configured with equal priority (e.g., priority) may be served equally.

As indicated by reference number 550, the UE 120 may transmit, and the network node 110 may receive, the MAC-TB (e.g., the MAC-TB generated using the LCP procedure described above in connection with reference number 545) using the uplink resources. More particularly, the data for which the UE 120 allocated uplink resources in light of the above-described LCP procedure may be multiplexed in the MAC-TB, and/or the MAC-TB may be transmitted to the network node 110.

Based at least in part on the network node 110 configuring and/or triggering the UE 120 to prioritize at least one DSR level (e.g., at least one Di level) and/or at least one PSI level (e.g., at least one Fi level), and/or based at least in part on the UE 120 performing an LCP procedure by allocating uplink resources based on prioritizing DSR-based traffic (e.g., based on performing Di-based prioritization) and/or prioritizing PSI-based traffic (e.g., based on performing Fi-based prioritization), the UE 120 and/or the network node 110 may conserve computing, power, network, and/or communication resources that may have otherwise been consumed by using semi-statically configured LCP procedures. For example, based at least in part on the network node 110 configuring and/or triggering the UE 120 to prioritize at least one DSR level (e.g., at least one Di level) and/or at least one PSI level (e.g., at least one Fi level), and/or based at least in part on the UE 120 performing an LCP procedure by allocating uplink resources based on prioritizing DSR-based traffic (e.g., based on performing Di-based prioritization) and/or prioritizing PSI-based traffic (e.g., based on performing Fi-based prioritization), the UE 120 and the network node 110 may communicate using optimized resource allocation and/or may communicate with reduced packet loss, which may conserve computing, power, network, and/or communication resources that may have otherwise been consumed to detect and/or correct communication errors and/or which may be been consumed by using FEC techniques to compensate for packet loss.

As indicated above, FIGS. 5A-5C are provided as examples. Other examples may differ from what is described with respect to FIGS. 5A-5C.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with LCP using DSR and PSI information.

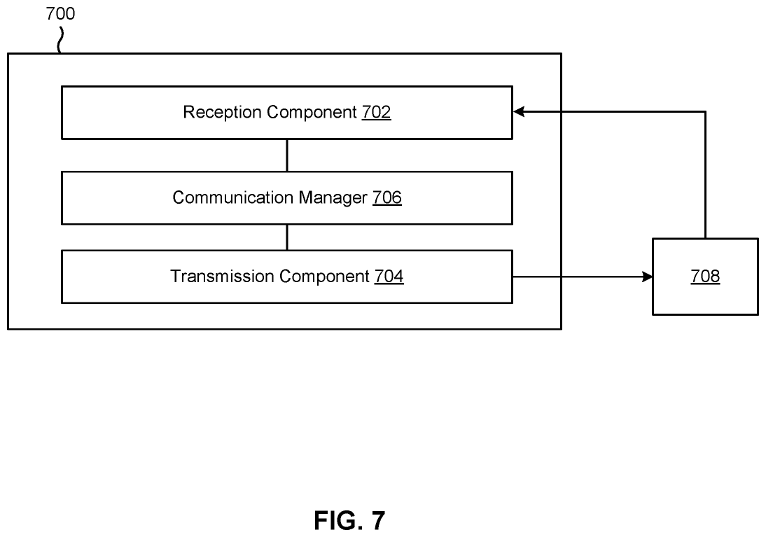

As shown in FIG. 6, in some aspects, process 600 may include allocating uplink resources to one or more logical channels based at least in part on an LCP procedure, wherein the LCP procedure is based at least in part on a logical channel priority parameter and at least one of a DSR parameter or a PSI parameter (block 610). For example, the UE (e.g., using communication manager 706, depicted in FIG. 7) may allocate uplink resources to one or more logical channels based at least in part on an LCP procedure, wherein the LCP procedure is based at least in part on a logical channel priority parameter and at least one of a DSR parameter or a PSI parameter, as described above.

As further shown in FIG. 6, in some aspects, process 600 may include transmitting a MAC-TB using the uplink resources based at least in part on allocating the uplink resources to the one or more logical channels (block 620). For example, the UE (e.g., using transmission component 704 and/or communication manager 706, depicted in FIG. 7) may transmit a MAC-TB using the uplink resources based at least in part on allocating the uplink resources to the one or more logical channels, as described above.

Process 600 may include additional aspects, such as any single aspect or any combination of aspects described below and/or in connection with one or more other processes described elsewhere herein.

In a first aspect, process 600 includes receiving a message indicating whether the at least one of the DSR parameter or the PSI parameter is to be considered when allocating the uplink resources to the one or more logical channels.

In a second aspect, alone or in combination with the first aspect, the message is received via a semi-static configuration communication.

In a third aspect, alone or in combination with one or more of the first and second aspects, the message is received via a dynamic communication.

In a fourth aspect, alone or in combination with one or more of the first through third aspects, the message is received based at least in part on one or more metrics derived from at least one of the UE or a network entity.

In a fifth aspect, alone or in combination with one or more of the first through fourth aspects, the one or more metrics are derived using an artificial intelligence/machine learning model.

In a sixth aspect, alone or in combination with one or more of the first through fifth aspects, the one or more metrics include at least one of a block error rate metric, a drop rate metric, a latency metric, a video condition metric, a channel quality metric, or a round trip time metric.

In a seventh aspect, alone or in combination with one or more of the first through sixth aspects, the message is based at least in part on a forward error correction procedure associated with data to be included in the MAC-TB.

In an eighth aspect, alone or in combination with one or more of the first through seventh aspects, the message is associated with at least one of a network slice, a quality of service flow, a network traffic pattern, a subcarrier spacing, a terrestrial network, or a nonterrestrial network.

In a ninth aspect, alone or in combination with one or more of the first through eighth aspects, allocating the uplink resources to the one or more logical channels based at least in part on the LCP procedure includes allocating a first portion of the uplink resources based at least in part on the DSR parameter, after allocating the first portion, allocating a second portion of the uplink resources based at least in part on the PSI parameter, and after allocating the second portion, allocating a third portion of the uplink resources based at least in part on the logical channel priority parameter.

In a tenth aspect, alone or in combination with one or more of the first through ninth aspects, allocating the uplink resources to the one or more logical channels based at least in part on the LCP procedure includes allocating a first portion of the uplink resources based at least in part on the PSI parameter, after allocating the first portion, allocating a second portion of the uplink resources based at least in part on the DSR parameter, and after allocating the second portion, allocating a third portion of the uplink resources based at least in part on the logical channel priority parameter.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 140 described in connection with FIG. 1. As shown, the apparatus 700 may communicate with another apparatus 708, such as a UE or a network node (such as a CU, a DU, an RU, or a base station), using the reception component 702 and the transmission component 704.

In some aspects, the apparatus 700 may be configured to perform one or more operations described herein in connection with FIGS. 5A-5C. Additionally, or alternatively, the apparatus 700 may be configured to perform one or more processes described herein, such as process 600 of FIG. 6. In some aspects, the apparatus 700 and/or one or more components shown in FIG. 7 may include one or more components of the UE 120 described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, one or more modems, one or more demodulators, one or more MIMO detectors, one or more receive processors, one or more controllers/processors, one or more memories, or a combination thereof, of the UE 120 described in connection with FIG. 2.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 708. In some aspects, the transmission component 704 may include one or more antennas, one or more modems, one or more modulators, one or more transmit MIMO processors, one or more transmit processors, one or more controllers/processors, one or more memories, or a combination thereof, of the UE 120 described in connection with FIG. 2. In some aspects, the transmission component 704 may be co-located with the reception component 702 in one or more transceivers.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The communication manager 706 may allocate uplink resources to one or more logical channels based at least in part on an LCP procedure, wherein the LCP procedure is based at least in part on a logical channel priority parameter and at least one of a DSR parameter or a PSI parameter. The transmission component 704 may transmit the MAC-TB using the uplink resources based at least in part on allocating the uplink resources to the one or more logical channels.

The reception component 702 may receive a message indicating whether the at least one of the DSR parameter or the PSI parameter is to be considered when allocating the uplink resources to the one or more logical channels.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: allocating uplink resources to one or more logical channels based at least in part on a logical channel prioritization (LCP) procedure, wherein the LCP procedure is based at least in part on a logical channel priority parameter and at least one of a delay status report (DSR) parameter or a protocol data unit (PDU) set importance (PSI) parameter; and transmitting a medium access control transport block (MAC-TB) using the uplink resources based at least in part on allocating the uplink resources to the one or more logical channels.

Aspect 2: The method of Aspect 1, further comprising receiving a message indicating whether the at least one of the DSR parameter or the PSI parameter is to be considered when allocating the uplink resources to the one or more logical channels.

Aspect 3: The method of Aspect 2, wherein the message is received via a semi-static configuration communication.

Aspect 4: The method of Aspect 2, wherein the message is received via a dynamic communication.

Aspect 5: The method of any of Aspects 2-4, wherein the message is received based at least in part on one or more metrics derived from at least one of the UE or a network entity.

Aspect 6: The method of Aspect 5, wherein the one or more metrics are derived using an artificial intelligence/machine learning model.

Aspect 7: The method of any of Aspects 5-6, wherein the one or more metrics include at least one of: a block error rate metric, a drop rate metric, a latency metric, a video condition metric, a channel quality metric, or a round trip time metric.

Aspect 8: The method of any of Aspects 2-7, wherein the message is based at least in part on a forward error correction procedure associated with data to be included in the MAC-TB.

Aspect 9: The method of any of Aspects 2-8, wherein the message is associated with at least one of: a network slice, a quality of service flow, a network traffic pattern, a subcarrier spacing, a terrestrial network, or a nonterrestrial network.

Aspect 10: The method of any of Aspects 1-9, wherein allocating the uplink resources to the one or more logical channels based at least in part on the LCP procedure includes: allocating a first portion of the uplink resources based at least in part on the DSR parameter, after allocating the first portion, allocating a second portion of the uplink resources based at least in part on the PSI parameter, and after allocating the second portion, allocating a third portion of the uplink resources based at least in part on the logical channel priority parameter.

Aspect 11: The method of any of Aspects 1-9, wherein allocating the uplink resources to the one or more logical channels based at least in part on the LCP procedure includes: allocating a first portion of the uplink resources based at least in part on the PSI parameter, after allocating the first portion, allocating a second portion of the uplink resources based at least in part on the DSR parameter, and after allocating the second portion, allocating a third portion of the uplink resources based at least in part on the logical channel priority parameter.

Aspect 12: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-11.

Aspect 13: An apparatus for wireless communication at a device, the apparatus comprising one or more memories and one or more processors coupled to the one or more memories, the one or more processors configured to cause the device to perform the method of one or more of Aspects 1-11.

Aspect 14: An apparatus for wireless communication, the apparatus comprising at least one means for performing the method of one or more of Aspects 1-11.

Aspect 15: A non-transitory computer-readable medium storing code for wireless communication, the code comprising instructions executable by one or more processors to perform the method of one or more of Aspects 1-11.

Aspect 16: A non-transitory computer-readable medium storing a set of instructions for wireless communication, the set of instructions comprising one or more instructions that, when executed by one or more processors of a device, cause the device to perform the method of one or more of Aspects 1-11.

Aspect 17: A device for wireless communication, the device comprising a processing system that includes one or more processors and one or more memories coupled with the one or more processors, the processing system configured to cause the device to perform the method of one or more of Aspects 1-11.

Aspect 18: An apparatus for wireless communication at a device, the apparatus comprising one or more memories and one or more processors coupled to the one or more memories, the one or more processors individually or collectively configured to cause the device to perform the method of one or more of Aspects 1-11.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
allocate uplink resources to one or more logical channels based at least in part on a logical channel prioritization (LCP) procedure,
wherein the LCP procedure is based at least in part on a logical channel priority parameter and at least one of a delay status report (DSR) parameter or a protocol data unit (PDU) set importance (PSI) parameter; and
transmit a medium access control transport block (MAC-TB) using the uplink resources based at least in part on allocating the uplink resources to the one or more logical channels.

2. The UE of claim 1, wherein the one or more processors are further configured to cause the UE to receive a message indicating whether the at least one of the DSR parameter or the PSI parameter is to be considered when allocating the uplink resources to the one or more logical channels.

3. The UE of claim 2, wherein the one or more processors, to receive the message, are configured to cause the UE to receive the message via a semi-static configuration communication.

4. The UE of claim 2, wherein the one or more processors, to receive the message, are configured to cause the UE to receive the message via a dynamic communication.

5. The UE of claim 2, wherein the one or more processors, to receive the message, are configured to cause the UE to receive the message based at least in part on one or more metrics derived from at least one of the UE or a network entity.

6. The UE of claim 5, wherein the one or more metrics are derived using an artificial intelligence/machine learning model.

7. The UE of claim 5, wherein the one or more metrics include at least one of:
a block error rate metric,
a drop rate metric,
a latency metric,
a video condition metric,
a channel quality metric, or
a round trip time metric.

8. The UE of claim 2, wherein the message is based at least in part on a forward error correction procedure associated with data to be included in the MAC-TB.

9. The UE of claim 2, wherein the message is associated with at least one of:
a network slice,
a quality of service flow,
a network traffic pattern,
a subcarrier spacing,
a terrestrial network, or
a nonterrestrial network.

10. The UE of claim 1, wherein the one or more processors, to cause the UE to allocate the uplink resources to the one or more logical channels based at least in part on the LCP procedure, are configured to cause the UE to:
allocate a first portion of the uplink resources based at least in part on the DSR parameter,
after allocating the first portion, allocating a second portion of the uplink resources based at least in part on the PSI parameter, and
after allocating the second portion, allocating a third portion of the uplink resources based at least in part on the logical channel priority parameter.

11. The UE of claim 1, wherein the one or more processors, to cause the UE to allocate the uplink resources to the one or more logical channels based at least in part on the LCP procedure, are configured to cause the UE to:
allocate a first portion of the uplink resources based at least in part on the PSI parameter,
after allocating the first portion, allocating a second portion of the uplink resources based at least in part on the DSR parameter, and
after allocating the second portion, allocating a third portion of the uplink resources based at least in part on the logical channel priority parameter.

12. A method of wireless communication performed by a user equipment (UE), comprising:
allocating uplink resources to one or more logical channels based at least in part on a logical channel prioritization (LCP) procedure,
wherein the LCP procedure is based at least in part on a logical channel priority parameter and at least one of a delay status report (DSR) parameter or a protocol data unit (PDU) set importance (PSI) parameter; and
transmitting a medium access control transport block (MAC-TB) using the uplink resources based at least in part on allocating the uplink resources to the one or more logical channels.

13. The method of claim 12, further comprising receiving a message indicating whether the at least one of the DSR parameter or the PSI parameter is to be considered when allocating the uplink resources to the one or more logical channels.

14. The method of claim 13, wherein the message is received via one of a semi-static configuration communication or a dynamic communication.

15. The method of claim 13, wherein the message is received based at least in part on one or more metrics derived from at least one of the UE or a network entity, and
wherein the one or more metrics are derived using an artificial intelligence/machine learning model.

16. The method of claim 15, wherein the one or more metrics include at least one of:
a block error rate metric,
a drop rate metric,
a latency metric,
a video condition metric,
a channel quality metric, or
a round trip time metric.

17. The method of claim 13, wherein the message is based at least in part on a forward error correction procedure associated with data to be included in the MAC-TB.

18. The method of claim 13, wherein the message is associated with at least one of:
a network slice,
a quality of service flow,
a network traffic pattern,
a subcarrier spacing,
a terrestrial network, or
a nonterrestrial network.

19. The method of claim 12, wherein allocating the uplink resources to the one or more logical channels based at least in part on the LCP procedure includes:
allocating a first portion of the uplink resources based at least in part on one of the DSR parameter or the PSI parameter,
after allocating the first portion, allocating a second portion of the uplink resources based at least in part on the other one of the DSR parameter or the PSI parameter, and
after allocating the second portion, allocating a third portion of the uplink resources based at least in part on the logical channel priority parameter.

20. A non-transitory computer-readable medium storing a set of instructions for wireless communication, the set of instructions comprising:
one or more instructions that, when executed by one or more processors of a user equipment (UE), cause the UE to:
allocate uplink resources to one or more logical channels based at least in part on a logical channel prioritization (LCP) procedure,
wherein the LCP procedure is based at least in part on a logical channel priority parameter and at least one of a delay status report (DSR) parameter or a protocol data unit (PDU) set importance (PSI) parameter; and
transmit a medium access control transport block (MAC-TB) using the uplink resources based at least in part on allocating the uplink resources to the one or more logical channels.
